(19) United States
(12) Patent Application Publication
(10) Pub. No.: US 2009/0326136 A1
(43) Pub. Date: Dec. 31, 2009

(54) PROPYLENE-BASED BLOCK COPOLYMER COMPOSITION AND EXTERIOR MEMBER FOR AUTOMOBILE

(75) Inventors: Kenji Masuda, Mie (JP); Ken Shimizu, Mie (JP); Minoru Adachi, Mie (JP); Hiroshi Inanami, Aichi-ken (JP); Kaoru Inoue, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: JAPAN POLYPROPYLENE CORPORATION, Minato-ku (JP); TOYOTA JIDOSHA KABUSHIKI KAISHA, Toyota-shi (JP)

(21) Appl. No.: 12/304,584

(22) PCT Filed: Jun. 15, 2007
(86) PCT No.: PCT/JP07/62544

§ 371 Date: Apr. 8, 2009

(30) Foreign Application Priority Data
Jun. 15, 2006 (JP) 2006-165659

(51) Int. Cl. C08K 3/34

(52) U.S. Cl. 524/451

(57) ABSTRACT

A polypropylene resin composition for molding material, which is excellent in an appearance of weld line and an appearance of tiger stripe and is used for automobile exterior parts and an automobile exterior part comprising the same, are provided. A propylene-based block copolymer composition, comprising 100 parts by weight of a propylene-based block copolymer having an MFR of 50 to 100 g/10 minutes and an Mw/Mn of 7 or less, wherein the propylene-based block copolymer comprises 75 to 95% by weight of a crystalline polypropylene portion and 5 to 25% by weight of an ethylene-propylene copolymer portion, where the ethylene content of the ethylene-propylene copolymer portion is 35 to 45% by weight and the ratio of the weight-average molecular weight of the ethylene-propylene copolymer portion to the weight-average molecular weight of the crystalline polypropylene portion is 3 to 5; 25 to 45 parts by weight of an ethylene-α-olefin copolymer elastomer having an MFR of 1 to 9 g/10 minutes; and 30 to 45 parts by weight of talc having an average particle diameter of 1.5 to 15 μm.

### TECHNICAL FIELD

The present invention relates to a propylene-based block copolymer composition for automobile exterior and an automobile exterior part using the same. Specifically, it relates to a propylene-based block copolymer composition for automobile exterior, which is excellent in a balance of an appearance of weld line and an appearance of tiger stripe and also a balance of physical properties and is satisfactory in injection moldability as well as an automobile exterior part using the same.

### BACKGROUND ART

Hitherto, polypropylene has been molded into parts by injection molding, for example, and thus widely utilized in various uses. In the automobile field, it is frequently used for relatively large parts such as bumpers and side mouldings. At the production of these parts, most of them have a design having an opening. In the molding of large parts, a material wherein weld is hardly visible is required. Moreover, in the products to be used for automobile exterior parts, they are used without coating and thus an appearance of tiger stripe is also important in addition to the appearance of weld line, so that it is necessary to satisfy them at the same time.

As a method for improving the appearance of molded articles, such as weld and flow mark, a method of using a resin composition comprising a propylene-ethylene block copolymer having a ratio Mw/Mn of weight-average molecular weight (Mw) to number-average molecular weight (Mn) of 5 to 15 and an MFR of 3 to 200 g/minutes, a styrene-based elastomer, and an inorganic filler is effective for flow marks (e.g., see Patent Document 1). Also, it is reported that, in a propylene-ethylene random copolymer polymerized by a specific catalyst and a propylene-based resin composition comprising the same, a method of allowing the propylene-ethylene random copolymer to have a specific angular frequency obtained from melt viscoelasticity measurement affords a good appearance of weld line (e.g., see Patent Document 2).

However, in these technologies, the improvement of the appearance is mainly focused on either one of the appearance of weld line or the appearance of tiger stripe and thus an improvement having both properties has not been obtained, so that a satisfactory level of combination of a good appearance of weld line and a good appearance of tiger stripe has not been achieved.

[Patent Document 1] JP-A-5-311032

[Patent Document 2] JP-A-8-151419

### DISCLOSURE OF THE INVENTION

An object of the invention is to solve the above problem, and to provide a polypropylene resin composition for molding materials, which is excellent in an appearance of weld line and an appearance of tiger stripe and is used for automobile exterior parts such as bumpers, and an automobile exterior part comprising the same.

As a result of various studies for solving the above problems, the present inventors have found that a propylene-based block copolymer composition comprising a propylene-based block copolymer having a specific structure, a specific ethylene-α-olefin copolymer elastomer, and talc having a specific particle diameter in a specific ratio is excellent in moldability and a balance of physical properties, especially has a good balance of an appearance of weld line and an appearance of tiger stripe, compared with conventional materials. Also, they have found that the composition is suitable for automobile exterior parts. Thus, they have accomplished the invention.

Namely, according to a first invention of the invention, there is provided the following propylene-based block copolymer composition for automobile exterior parts.

(1) A propylene-based block copolymer composition, comprising the following components (I) to (III):

Component (I): 100 parts by weight of a propylene-based block copolymer having an MFR (230° C., 21.18N load) of 50 to 100 g/10 minutes and a molecular weight distribution (Mw/Mn) of 7 or less, wherein the propylene-based block copolymer comprises 75 to 95% by weight of a crystalline polypropylene portion (I₁) and 5 to 25% by weight of an ethylene-propylene copolymer portion (I₂), in which the total amount of the crystalline polypropylene portion (I₁) and the ethylene-propylene copolymer portion (I₂) is 100% by weight, and the ethylene content of the ethylene-propylene copolymer portion (I₂) is 35 to 45% by weight, and the ratio (MwCH=Mw−C/Mw−H) of the weight-average molecular weight (Mw−C) of the ethylene-propylene copolymer portion (I₂) to the weight-average molecular weight (Mw−H) of the crystalline polypropylene portion (I₁) is 3 to 5;

Component (II): 25 to 45 parts by weight of an ethylene-α-olefin copolymer elastomer having an MFR (230° C., 21.18N load) of 1 to 9 g/10 minutes;

Component (III): 30 to 45 parts by weight of talc having an average particle diameter of 1.5 to 15 μm.

(2) The propylene-based block copolymer composition according to the item (1), which has a MFR of 30 to 40 g/10 minutes, a flexural modulus of 2000 to 2200 MPa, and a low-temperature Izod impact strength of 45 to 50 J/m.

(3) An automobile exterior part, which is formed by injection molding of the propylene-based block copolymer composition according to the item (1) or (2).

Since the propylene-based block copolymer composition of the invention is excellent in moldability and a balance of physical properties, especially has a good balance of an appearance of weld line and an appearance of tiger stripe as compared with conventional materials, the composition is suitable for automobile exterior parts.

### BEST MODE FOR CARRYING OUT THE INVENTION

The invention relates to a propylene-based block copolymer composition for automobile exterior parts, comprising (I) a propylene-based block copolymer, (II) an ethylene-α-olefin copolymer elastomer, and (III) talc, and an automobile exterior part using the same. The following will describe the constitutional components of the propylene-based block copolymer composition, a process for producing the propylene-based block copolymer composition, and molding of the propylene-based block copolymer composition.

### 1. Propylene-Based Block Copolymer Composition

### (I) Propylene-Based Block Copolymer

The propylene-based block copolymer for use in the propylene-based block copolymer composition of the invention is a propylene-ethylene block copolymer comprising a crystalline polypropylene portion (I₁) obtained by homopolymerization of propylene and an ethylene-propylene copolymer portion (I₂) obtained by copolymerization of ethylene and propylene.

In the propylene-based block copolymer of the invention, the content of the crystalline polypropylene portion (I₁) is 75 to 95% by weight, preferably 77 to 85% by weight. Moreover, the content of the ethylene-propylene copolymer portion (I₂) is 5 to 25% by weight, preferably 10 to 23% by weight. When the content of the crystalline polypropylene portion (I₁) is smaller than the above range, the heat-resistant rigidity of the propylene-based block copolymer composition is insufficient. On the other hand, when the content is larger than the above range, the impact strength and coating ability of the propylene-based block copolymer composition are poor.

Furthermore, the ethylene content of the ethylene-propylene copolymer portion (I₂) is 35 to 45% by weight, preferably 40 to 45% by weight. When the ethylene content of the ethylene-propylene copolymer portion (I₂) is smaller than the above range, impact strength of the propylene-based block copolymer composition is insufficient. On the other hand, when the content is larger than the above range, the heat-resistant rigidity of the propylene-based block copolymer composition is poor.

The ethylene-propylene random copolymer portion (I₂) is preferably an ethylene-propylene random copolymer portion.

Herein, the ethylene content of the ethylene-propylene copolymer portion (I₂) in the propylene-ethylene block copolymer is a value obtained by immersing 2 g of a propylene-ethylene block copolymer sample in 300 g of boiling xylene for 20 minutes to dissolve the sample, subsequently cooling the solution to room temperature, removing the precipitated solid phase through a glass filter to remove it, evaporating the filtrate resulting from the filtration of the precipitate at room temperature to dryness, and measuring the ethylene content of the resulting solid matter using infrared spectroscopic analysis.

The MFR (230° C., 21.18N load) of the whole propylene-based block copolymer is 50 to 100 g/10 minutes, preferably 60 to 90 g/10 minutes. When the MFR of the whole is smaller than the above range, the moldability of the propylene-based block copolymer composition is poor. On the other hand, when it is larger than the above range, the impact strength of the propylene-based block copolymer composition is unsatisfactory.

Herein, the MFR is a value obtained by the measurement in accordance with JIS-K7210 (230° C., 21.18N)

Moreover, the weight-average molecular weight/number-average molecular weight (Mw/Mn) of the propylene-based block copolymer is 7 or less, preferably 6.5 or less. When the weight-average molecular weight/number-average molecular weight (Mw/Mn) exceeds 7, the appearance of weld line is insufficient.

Furthermore, the ratio (MwCH=Mw−C/Mw−H) of the weight-average molecular weight (Mw−C) of the ethylene-propylene copolymer portion (I₂) to the weight-average molecular weight (Mw−H) of the crystalline polypropylene portion (I₁) is 3 to 5, preferably 3.2 to 4.5. When (MwCH=Mw−C/Mw−H) falls out of the above range, a weld-flow mark balance becomes bad.

The molecular weight of the crystalline polypropylene portion and that of the ethylene-propylene copolymer portion can be controlled by increasing or decreasing the amount of a molecular weight-controlling agent such as hydrogen present at the polymerization. MwCH can be controlled by regulating each molecular weight at the polymerization step. Moreover, the regulation of the molecular weight distribution can be conducted by hydrogen concentration, polymerization pressure, and polymerization time at the polymerization.

In the invention, a soluble portion of the propylene-based block copolymer in o-dichlorobenzene at 40° C. is used as the ethylene-propylene copolymer portion (I₂) and the remaining portion is used as the crystalline polypropylene portion (I₁).

Herein, the weight-average molecular weight (Mw−H) of the crystalline polypropylene portion (I₁) and the weight-average molecular weight (Mw−C) of the ethylene-propylene copolymer portion (I₂) are values determined by the following method.

Namely, temperature is elevated using o-dichlorobenzene as a solvent to extract a component eluting at 40° C. or lower, which is used as the ethylene-propylene random copolymer portion and a weight-average molecular weight is determined by gel permeation chromatography (GPC) to be Mw−C. Moreover, a component eluting at 40 to 140° C. is used as the homopolypropylene portion and Mw−H is similarly determined by GPC. Also, Mw/Mn is a value measured by GPC.

With regard to the production of the propylene-ethylene block copolymer, it can be produced by multi-step polymerization comprising a polymerization step for mainly producing crystalline polypropylene and a polymerization step for mainly producing an ethylene-propylene copolymer. In the polymerization step for producing crystalline polypropylene, propylene or propylene and an α-olefin other than propylene and copolymerizable with propylene are brought into contact with a polymerization catalyst to obtain a polymer. In the polymerization step for producing an ethylene-propylene copolymer, propylene and ethylene is brought into contact with a polymerization catalyst to obtain a copolymer.

The polymerization mode of each polymerization step is not particularly limited and the polymers are produced by a known mode, i.e., a slurry polymerization method, a vapor-phase polymerization method, or a liquid-phase bulk polymerization method. If anything, in view of coating ability and cost, it is preferred to produce them by the vapor-phase polymerization method.

Each polymerization step may be one-stage polymerization or multi-stage, i.e., two- or more-stage polymerization. In this connection, as the polymerization method, either method of batch polymerization and continuous polymerization can be employed but production by continuous polymerization is preferred. At the production of the propylene-ethylene block copolymer, in view of quality, preferred is one wherein a crystalline propylene homopolymer portion is first formed by homopolymerization of propylene and the ethylene-propylene random copolymer portion is then formed by random copolymerization of propylene with ethylene.

As the polymerization catalyst, a known catalyst can be used without limitation and, for example, Ziegler catalysts, metallocene catalysts, and the like can be employed. As Ziegler catalysts, there may be mentioned catalysts wherein an organoaluminum compound component is combined with a solid component formed by bringing magnesium chloride into contact with titanium tetrachloride, an organic halide, and an organosilicon compound.

Moreover, the propylene-ethylene block copolymer may be a ternary or other multi-component copolymer containing other unsaturated compound(s), e.g., an α-olefin such as 1-butene, a vinyl ester such as vinyl acetate, or an unsaturated organic acid such as maleic anhydride or a derivative thereof or may be a mixture thereof.

### (II) Ethylene-α-Olefin Copolymer Elastomer

The ethylene-α-olefin copolymer elastomer for use in the propylene-based block copolymer composition of the invention is a copolymer elastomer of ethylene and an α-olefin, e.g., an α-olefin having 3 to 12 carbon atoms. As the α-olefin, for example, propylene, butene-1, hexene-1, octene-1, and the like may be mentioned.

The MFR (230° C., 21.18N) of the ethylene-α-olefin copolymer elastomer is 1 to 9 g/10 minutes, preferably 1.5 to 5 g/10 minutes. When the MFR is less than 1 g/10 minutes, the moldability and coating ability thereof are poor. When the MFR exceeds 9 g/10 minutes, the impact resistant thereof is poor.

Herein, the MFR of the ethylene-α-olefin copolymer elastomer is a value obtained by the measurement in accordance with JIS-K7210 (230° C., 21.18N).

With regard to the production of the ethylene-α-olefin copolymer elastomer, it can be obtained by polymerization using a known titanium-based catalyst or a metallocene catalyst.

The mixing ratio of the ethylene-α-olefin copolymer elastomer in the propylene-based block copolymer composition of the invention is 25 to 45 parts by weight, preferably 30 to 40 parts by weight relative to 100 parts by weight of the propylene-based block copolymer. When the amount of the ethylene-α-olefin copolymer elastomer is less than 25 parts by weight, an improved effect of the impact resistance of the propylene-based block copolymer composition is not observed. On the other hand, when the amount exceeds 50 parts by weight, the rigidity and thermal resistance of the propylene-based block copolymer composition decrease.

### (III) Talc

The talc for use in the propylene-based block copolymer composition of the invention is employed for the purpose of enhancing rigidity, regulating size stability, and the like.

The talc for use in the invention necessarily has an average particle diameter of 1.5 to 15 μm, preferably 2 to 8 μm in view of appearance and impact strength.

The talc is produced by pulverizing a talc rough stone by an impact type pulverizer and a micron mill type pulverizer or is produced by further pulverization by a jet mill and subsequently classification and adjustment by a cyclone, a micron separator, or the like. The average particle diameter of the talc can be measured using a laser diffraction scattering type granulometer (e.g., Horiba, Ltd., LA-920 model).

Moreover, a so-called compressed talc having an apparent volume weight ratio of 2.50 ml/g or less may be used. Furthermore, the talc may be surface-treated with metal soap, paraffin wax, polyethylene wax or a modified one thereof, an organic silane, an organic boran, an organic titanate, or the like.

The mixing ratio of the talc in the propylene-based block copolymer composition of the invention is 30 to 45 parts by weight, preferably 35 to 40 parts by weight relative to 100 parts by weight of the propylene-based block copolymer. When the amount of the talc is less than 30 parts by weight, an improved effect of the rigidity of the propylene-based block copolymer composition is not observed. On the other hand, when the amount exceeds 45 parts by weight, the impact resistance of the propylene-based block copolymer composition decrease.

### (IV) Other Components

The propylene-based block copolymer composition of the invention may contain other additives such as heat stabilizers, antioxidants, light stabilizers, flame retardants, nucleating agents, plasticizers, antistatic agents, copper inhibitors, releasing agents, foaming agents, colorants, pigments, and dispersants thereof, for example, depending on the applications such as automobile exterior materials for the purpose of modification thereof. The above various additives and pigments are generally added during the mixing of individual components but a master batch having a high concentration may be formed beforehand and post-blended during injection molding or extrusion molding.

### 2. Production and Properties of Propylene-Based Block Copolymer Composition

The propylene-based block copolymer composition for use in the invention can be obtained by mixing the above component (I): a propylene block copolymer, component (II): an ethylene-α-olefin copolymer elastomer, and component (III): talc, and if necessary, the other components in the above mixing ratio and kneading them using a usual kneader such as a single-screw extruder, a twin-screw extruder, a Banbury mixer, a roll mixer, a Brabender plastograph, or a kneader. In this case, a kneading method capable of homogeneous dispersion of individual components is preferred and usually, kneading is conducted using a twin-screw extruder. At the kneading, a formulation of the above individual components may be simultaneously kneaded or sequentially kneaded.

The propylene-based block copolymer composition of the invention has an MFR of preferably 30 to 40 g/10 minutes, more preferably 30 to 35 g/10 minutes, a flexural modulus of preferably 2000 to 2200 MPa, more preferably 2040 to 2200 MPa, and a low-temperature Izod impact strength of preferably 45 to 50 J/m, more preferably 47 to 50 J/m. When the individual values fall within the above ranges, necessary performance is satisfied after the composition is processed into various molded articles.

Herein, the MFR is a value measured in accordance with JIS-K7210 (230° C., 21.18N load), the flexural modulus is a value measured at 23° C. in accordance with JIS-K7203, and the low-temperature Izod impact strength is a value measured at −30° C. in accordance with JIS-K7110.

### 3. Molding of Propylene-Based Block Copolymer Composition

With regard to the molded articles of the invention, various molded articles are produced from the propylene-based block copolymer composition obtained as above by known injection molding methods (inclusive of gas injection molding). The resulting molded articles are excellent in weld-flow mark properties, rigidity, and low-temperature impact resistance. In particular, the propylene-based block copolymer composition for use in the invention obtained by the above method has not only the weld-flow mark properties but also a high balance of physical properties (rigidity and low-temperature impact strength) and a more excellent injection moldability (weld mark, flow mark), so that the composition has properties sufficient for practical uses in the fields of various industrial parts, for example, as automobile exterior parts such as bumpers and side mouldings.

### EXAMPLES

The following will further specifically describe the invention with reference to Examples and Comparative Examples but the invention is not limited thereto. The test methods, evaluation methods, and raw materials used in Examples and Comparative Examples are as follows.

### 1. Test/Evaluation Methods

(1) MFR: measured in accordance with JIS-K7210 (230° C., 21.18N load).
(2) Ethylene content: measured in accordance to the aforementioned method.
(3) Flexural modulus (unit: MPa): measured at 23° C. in accordance with JIS-K7203.
(4) Izod impact strength (unit: J/m): measured at −30° C. in accordance with JIS-K7110.
(5) Appearance of tiger stripe: a molded sheet having a size of 350 mm×100 mm×2 mm was obtained by injection molding at a molding temperature of 220° C. using a mold having a film gate with a width of 2 mm on a short side by means of an injection molding machine exhibiting a mold clamping pressure of 170 tons. Occurrence of a flow mark was visually observed and a distance from the gate to the part where the flow mark occurred was measured, thereby the sheet being judged according to the following standard.

◯: the occurrence distance exceeds 200 mm

Δ: the occurrence distance exceeds 150 mm

X: the occurrence distance is 200 mm or less

(6) Appearance of weld line: a flat-model molded article having a thickness of 4 mm and an opening provided therein was obtained by injection molding at 220° C. by means of an injection molding machine exhibiting a mold clamping pressure of 170 tons and conspicuousness of weld line at the place where the weld occurred was evaluated according to the following standard.

◯: hardly conspicuous

Δ: slightly conspicuous

X: considerably conspicuous

### 2. Raw Materials

### (1) Propylene-Based Block Copolymer

Propylene-based block copolymers (PP1 to PP8) whose physical properties were shown in Table 1 were used.

TABLE 1
Propylene-ethylene block copolymer

| | | Ethylene-propylene | | | | |
|---|---|---|---|---|---|---|
| | Crystalline | copolymer portion | | | | |
| | polypropylene | (I₂) | | | | |
| | portion (I₁) | | Ethylene | | | MFR |
| | Ratio | Ratio | content | MwCH | Mw/Mn | (g/ |
| Kind | (wt %) | (wt %) | (wt %) | — | — | 10 min) |
| PP-1 | 83 | 17 | 42 | 3.3 | 6.3 | 65 |
| PP-2 | 87 | 13 | 43 | 3 | 6 | 85 |
| PP-3 | 92 | 8 | 43 | 3.7 | 5 | 65 |
| PP-4 | 90 | 10 | 45 | 10 | 7.7 | 90 |
| PP-5 | 90 | 10 | 44 | 7.5 | 7.2 | 100 |
| PP-6 | 82 | 18 | 40 | 2.2 | 5.5 | 30 |
| PP-7 | 76 | 24 | 38 | 4 | 7.5 | 90 |
| PP-8 | 93 | 7 | 44 | 5.5 | 6.8 | 85 |

### (2) Ethylene-α-Olefin Copolymer Elastomer

EOR1:(ethylene-octene rubber: manufactured by Du Pont Dow): MFR=2 g/10 minutes

EOR2:(ethylene-octene rubber: manufactured by Du Pont Dow): MFR=10 g/10 minutes

EBM1:(ethylene-butene rubber: manufactured by Mitsui Chemicals Inc.): MFR=2.4 g/10 minutes

### (3) Talc

Finely powdered talc (manufactured by Fuji Talc Industrial Co., Ltd.): average diameter of 5.9 μm, aspect ratio of 6

### Examples 1 to 4

After the components (I) to (III) were mixed in a ratio shown in Table 2 and dry-blended using a super mixer, the raw materials were supplied from a hopper, melt-kneaded using a high-speed twin-screw extruder (KCM) manufactured by Kobe Steel, Ltd., and extruded to obtain pellets. The resulting pellets were subjected to injection molding at a resin temperature of 210° C. and a mold temperature of 30° C. to produce a test piece for physical properties, followed by evaluation. Evaluation results are shown in Table 3.

As shown in Table 3, the propylene-based block copolymer compositions having compositions shown in Examples 1 to 4 all exhibit a satisfactory balance of physical properties.

### Comparative Examples 1 to 6

The components (I) to (III) were mixed in a ratio shown in Table 2 and a test piece for physical properties was produced, followed by evaluation. When MwCH and Mw/Mn fall out of specific values, the flow mark-weld properties thereof become poor.

TABLE 2

| | Propylene-based block copolymer composition | | | | |
|---|---|---|---|---|---|
| | Propylene-ethylene | | Ethylene-α-olefin | | |
| | block copolymer | | copolymer elastomer | | |
| | (I) | | (II) | | Talc (III) |
| | | Parts by | | Parts by | Parts by |
| | Kind | weight | Kind | weight | weight |
| Example 1 | PP-1 | 100 | EOR-1 | 31 | 38 |
| Example 2 | PP-2 | 100 | EOR-1 | 35 | 37 |
| Example 3 | PP-3 | 100 | EOR-1 | 43 | 40 |
| Example 4 | PP-2 | 100 | EBM-1 | 35 | 37 |
| Comparative | PP-4 | 100 | EOR-1 | 40 | 38 |
| Example 1 | | | | | |
| Comparative | PP-5 | 100 | EOR-1 | 40 | 38 |
| Example 2 | | | | | |
| Comparative | PP-6 | 100 | EOR-1 | 32 | 38 |
| Example 3 | | | | | |
| Comparative | PP-7 | 100 | EOR-1 | 30 | 37 |
| Example 4 | | | | | |
| Comparative | PP-8 | 100 | EOR-1 | 44 | 39 |
| Example 5 | | | | | |
| Comparative | PP-2 | 100 | EOR-2 | 35 | 37 |
| Example 6 | | | | | |

TABLE 3

| | Physical properties of propylene-based | | | | |
|---|---|---|---|---|---|
| | block copolymer composition | | | | |
| | | | Izod | | |
| | | | impact | Appearance | Appearance |
| | MFR | Flexural | strength | of tiger | of weld |
| | (g/10 | modulus | −30° C. | stripe | line |
| | min) | (MPa) | (J/m) | — | — |
| Example 1 | 32 | 2015 | 47 | ◯ | ◯ |
| Example 2 | 34 | 2070 | 45 | ◯ | ◯ |
| Example 3 | 32 | 2010 | 47 | Δ | ◯ |
| Example 4 | 33 | 2040 | 48 | ◯ | ◯ |
| Comparative | 32 | 2040 | 46 | ◯ | X |
| Example 1 | | | | | |
| Comparative | 35 | 2010 | 46 | ◯ | X |
| Example 2 | | | | | |
| Comparative | 15 | 2000 | 48 | X | ◯ |
| Example 3 | | | | | |
| Comparative | 33 | 2080 | 45 | Δ | X |
| Example 4 | | | | | |
| Comparative | 34 | 2100 | 46 | X | Δ |
| Example 5 | | | | | |
| Comparative | 48 | 2090 | 39 | ◯ | ◯ |
| Example 6 | | | | | |

### INDUSTRIAL APPLICABILITY

Since the present invention is a propylene-based block copolymer composition excellent in moldability and a balance of physical properties and especially having a good balance of an appearance of weld line and an appearance of tiger stripe, molded articles obtained therefrom are excellent in weld-flow mark properties, rigidity, and low-temperature impact resistance. Therefore, the articles can be suitably used in the fields of various industrial parts, for example, as automobile exterior parts such as bumpers and side mouldings.

This application is based on Japanese patent application JP 2006-165659, filed on Jun. 15, 2006, the entire content of which is hereby incorporated by reference, the same as if set forth at length.

1. A propylene-based block copolymer composition, comprising the following components (I) to (III):
Component (I): 100 parts by weight of a propylene-based block copolymer having an MFR (230° C., 21.18N load) of 50 to 100 g/10 minutes and a molecular weight distribution (Mw/Mn) of 7 or less, wherein the propylene-based block copolymer comprises 75 to 95% by weight of a crystalline polypropylene portion (I₁) and 5 to 25% by weight of an ethylene-propylene copolymer portion (I₂), in which the total amount of the crystalline polypropylene portion (I₁) and the ethylene-propylene copolymer portion (I₂) is 100% by weight, and the ethylene content of the ethylene-propylene copolymer portion (I₂) is 35 to 45% by weight, and the ratio (MwCH=Mw−C/Mw−H) of the weight-average molecular weight (Mw−C) of the ethylene-propylene copolymer portion (I₂) to the weight-average molecular weight (Mw−H) of the crystalline polypropylene portion (I₁) is 3 to 5;
Component (II): 25 to 45 parts by weight of an ethylene-α-olefin copolymer elastomer having an MFR (230° C., 21.18N load) of 1 to 9 g/10 minutes;
Component (III): 30 to 45 parts by weight of talc having an average particle diameter of 1.5 to 15 μm.

2. The propylene-based block copolymer composition according to claim 1, which has a MFR of 30 to 40 g/10 minutes, a flexural modulus of 2000 to 2200 MPa, and a low-temperature Izod impact strength of 45 to J/m.

3. An automobile exterior part, which is formed by injection molding of the propylene-based block copolymer composition according to claim 1 or 2.
